(19) United States
(12) Patent Application Publication
(10) Pub. No.: US 2009/0120044 A1
(43) Pub. Date: May 14, 2009

(54) SUCTION ASSISTED CONTAINER CLOSURE SYSTEM

(76) Inventor: Acie Ray Fields, Danielsville, GA (US)

Correspondence Address: THOMPSON HINE L.L.P.;Intellectual Property Group, P.O. BOX 8801, DAYTON, OH, 45401-8801, US

(21) Appl. No.: 12/270,284

(22) Filed: Nov. 13, 2008

Related U.S. Application Data
(60) Provisional application No. 60/987,814, filed on Nov. 14, 2007.

(51) Int. Cl. B67B 3/20; B65B 7/28; B65G 47/00; B65G 47/91

(52) U.S. Cl. 53/490; 53/329; 53/331.5; 53/485; 198/471.1

(57) ABSTRACT

A container handling system for applying closures to containers includes a container feed line and a capping station for receiving containers from the container feed line and applying closures thereto. The capping station includes a capping head configured to provide torque during closure application. A container holder is configured to resist container rotation. The holder includes an opening exposed to a container location and a device positioned to draw air from the container location through the opening to create a force the acts to pull the container toward the opening.

### CROSS-REFERENCE TO RELATED APPLICATIONS

This application claims priority to U.S. Provisional Patent Application No. 60/987,814, filed Nov. 14, 2007, the details of which are incorporated by reference in their entirety.

### TECHNICAL FIELD

The present application relates generally to systems for applying closures to containers, and more particularly to a system that uses suction to resist container rotation during application of a closure to the container.

### BACKGROUND

The manufacture of containers is in many cases complicated by the necessary application of a closure to the container. The closure must be properly and securely attached so that the container is completely closed, but in mass production, this process must occur with great speed as well as accuracy.

In the case of closures that must be applied with rotational force, a certain amount of torque must be applied to achieve the desired level of “cap tightness”. The required tightness is affected by many factors, including design details of the closure and container such as materials, certain dimensions, tolerances, and the methods of sealing to achieve adequate leak prevention, as well as the use of various methods of tamper-evidence. To achieve the required level of tightness, a torque must be exerted to rotate the closure while a force is exerted on the container to allow it to resist rotation. A number of different systems are well-known to exert a resistive force on the container.

For containers that have non-round shapes (oval, square, rectangular, or similar) the machine components that position the container under the capping head are configured with shaped openings into which the container fits tightly enough to prevent rotation about the vertical axis of the opening receiving the closure, due simply to the non-round shape being constrained by the shaped pocket.

For containers that have a circular shape centered on the vertical axis, some alternate means of resisting rotation must be applied. These may include the addition of high-friction (often resilient) materials used to line the pockets. A tensioning belt may be employed to apply side force against the container to improve “seating” into the lining material.

When the container is very flexible, the side forces to seat the container may deform the container's side walls, which may damage or deform the container. If a certain small part of the container is especially resilient, it may be possible to design mechanical pieces to grip that resilient part. Alternately, by gripping evenly around the entire area of the container, it may be possible to apply enough force to resist rotation. However, both of these methods involve increased complexity and cost for the closure system, and are not always successful in accomplishing the resistance objective.

It would desirable to have a system for container closure that could exert sufficient force to resist rotation of the container without risk of deforming or damaging the container, that could be applied to both non-round and round containers of a variety of sizes and materials, and that does not accrue the costs associated with systems involving numerous precisely allocated mechanical parts.

### SUMMARY

In certain aspects, the invention involves a device for container closure that includes a container holder with an opening through which air is drawn out of the container location so that the container is pulled toward the opening.

In an aspect, a container handling system for applying closures to containers includes a container feed line and a capping station for receiving containers from the container feed line and applying closures thereto. The capping station includes a capping head configured to provide torque during closure application. A container holder is configured to resist container rotation. The holder includes an opening exposed to a container location and a device positioned to draw air from the container location through the opening to create a force the acts to pull the container toward the opening.

In another aspect, a method for applying a closure to a container is provided. The method includes bringing the closure and the container in contact. Torque is applied to the closure. A vacuum force is exerted on the container to urge the container into contact with another member developing a frictional force that resists rotation of the container during the application of torque to the closure.

In another aspect, a container handling system for applying closures to containers includes a container feed line and a capping station for receiving containers from the container feed line and applying closures thereto. The capping station includes a capping head configured to provide torque during closure application. A container holder includes a container engaging surface. A vacuum system is connected to the container holder that draws the container against the container engaging surface. The container engaging surface and vacuum system cooperate to inhibit rotation of the container during the closure application.

### BRIEF DESCRIPTION OF THE DRAWINGS

FIG. 1 illustrates an embodiment of a container closure system;

FIG. 2 is an angled view of a container holder shown holding a container;

FIG. 3 is a side view and force diagram of a container holder shown holding a container;

FIGS. 4a-4e are different views of components of a vacuum plate that acts as a container holder;

FIG. 5 is an embodiment of a container holder including a set of container guides;

FIGS. 6 and 7 show an embodiment of a container holder utilizing side suction;

FIG. 8 illustrates an exemplary pneumatic schematic;

FIG. 9 illustrates an embodiment of a closure applying system; and

FIGS. 10 and 11 illustrate an embodiment of a closure applying system.

### DETAILED DESCRIPTION

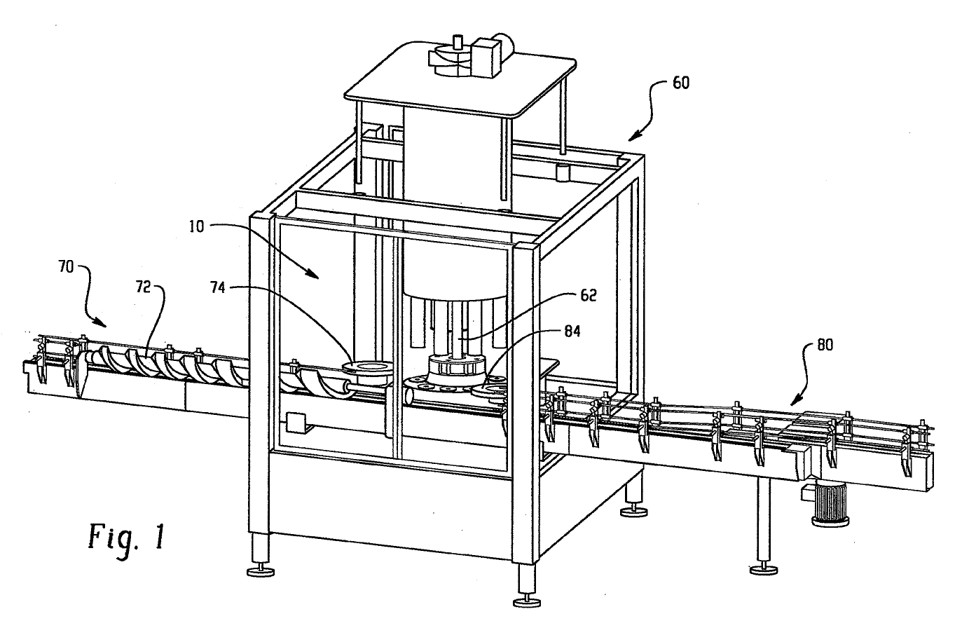

FIG. 1 shows a container closure system according to one embodiment. Open containers approach a capping station 60 on an infeed conveyer 70 which uses an infeed screw 72. Each open container moves from the infeed conveyer 70 to an infeed starwheel 74 and then onto a container holder 10 of a closure applying station. In this embodiment, the container holder takes the form of a vacuum plate assembly, but additional positioning and holding structure may also be provided. As a capper head 62 screws a closure onto the container, the vacuum plate assembly holds the container in place. The closed container exits the capping station 60 via a discharge starwheel 84 onto a discharge conveyer 80. Multiple container holders and corresponding capper heads may be provided as shown, with the components rotating together around a central axis of the capping station during closure application. Other closure system configurations are also contemplated, including tangential infeed systems with no infeed starwheel, and single head cappers with intermittent infeed or manual infeed.

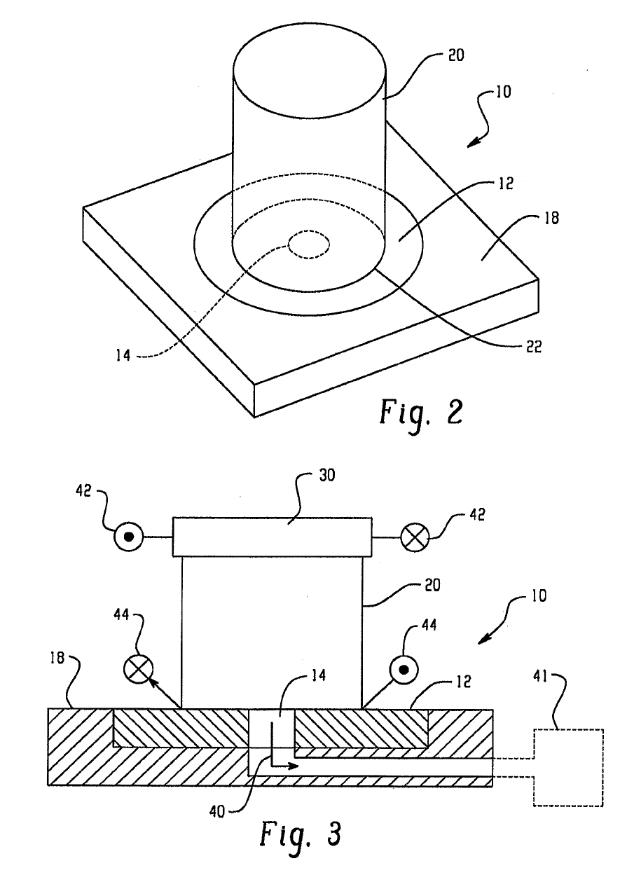

Referring to FIG. 2, an exemplary container holder 10 is shown including a resilient ring 12 and a central opening 14. The resilient ring 12 is set in a solid surface 18, which is preferably a rigid material that is part of the container conveyance system. An edge 22 of the bottom surface of the container 20 surrounds the opening 14 and seats against the top of the ring 12. Air is drawn through the opening 14 to create a force that will pull the container downward toward the resilient ring 12.

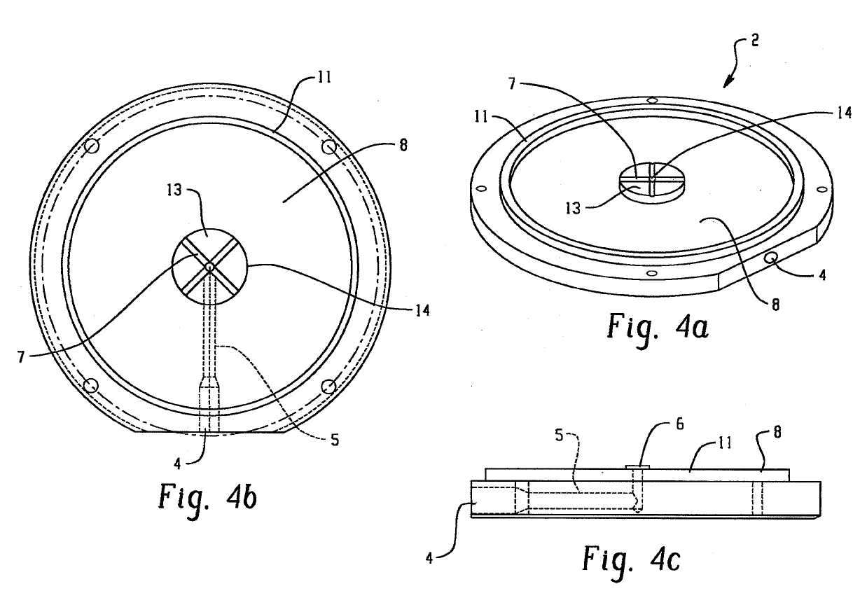

FIG. 3 shows a side view partial cross-section of a container holder. As air is drawn through the opening 14 in the direction of arrow 40, the pressure gradient results in a downward force on the container 20 that pulls the container into more aggressive contact with the resilient ring 12, increasing the force of the container 20 loading the ring 12, and yielding higher frictional force resisting rotation thereby increasing the system's ability to resist sliding rotational movement of the container 20 relative to the holder 10.

As the closure 30 contacts the container 20, the capping head 62 (FIG. 1) exerts a rotational torque 42 on the closure 30, which is also exerted on the container 20 in contact with the closure 30. The torque 42 causes a force of friction 44 at the contact surface of the container 20 and the resilient ring 12. The force of friction 44 is rotationally in the opposite direction from the torque 42. Frictional torque 44 opposes torque 42, resisting the rotation of the container. As the closure 30 moves clockwise while the container 20 does not, the closure 30 is applied and the container 20 is closed. A vacuum source 41 may be used to draw air through the opening 14.

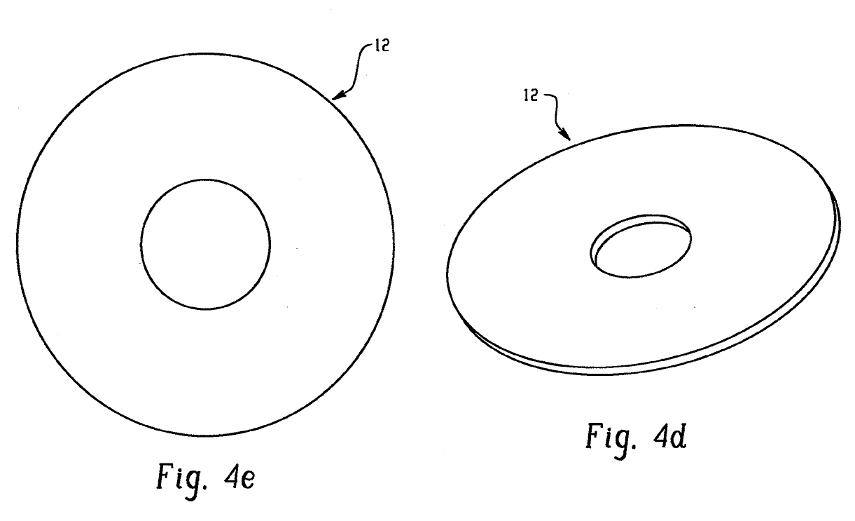

A container holder which pulls a container downward by communication with the container bottom may be configured as shown in FIGS. 4a-4e. FIGS. 4a-4c show a stainless steel vacuum plate 2 which includes an annular depression 8 shaped to hold the rubber disk 12 shown in 4d and 4e. The annular depression 8 forms a volume that is bounded by an annular wall 11 spaced radially from a boss 13 in a center of the volume. Air is drawn through a vacuum outlet hole 14 which communicates with a vacuum pump (not shown). The vacuum outlet hole 14 extends through the boss 13 and is in communication with an interior vacuum passage 5 which in turn connects to an opening 4. A set of cross-wise grooves 7 are cut into the surface of the boss 13 surrounding the opening 14 to help assure communication of the area beneath the container with the vacuum passage 5. As air is drawn through the vacuum outlet hole 4, air is drawn through the opening 4, creating suction at the opening 14 to pull a container against the rubber disk 12.

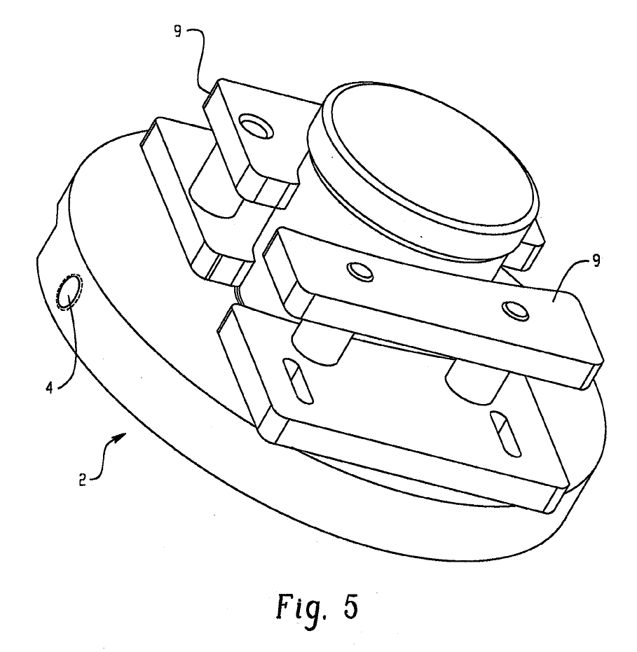

FIG. 5 shows another embodiment of a container holder 10 using a vacuum plate 2. Here, the container 20 is bracketed by a set of container guides 9. The container guides 9 may be capable of movement (e.g., through the use of actuators) horizontally toward and away from each other to receive, hold and release the container 20. Vacuum reaches the bottom of the container 20 through an interior vacuum passage that communicates with a vacuum pump through vacuum outlet hole 4, as above. Container guides 9 may exert additional friction on the container 20, or may simply be used to assure that the container 20 is properly positioned.

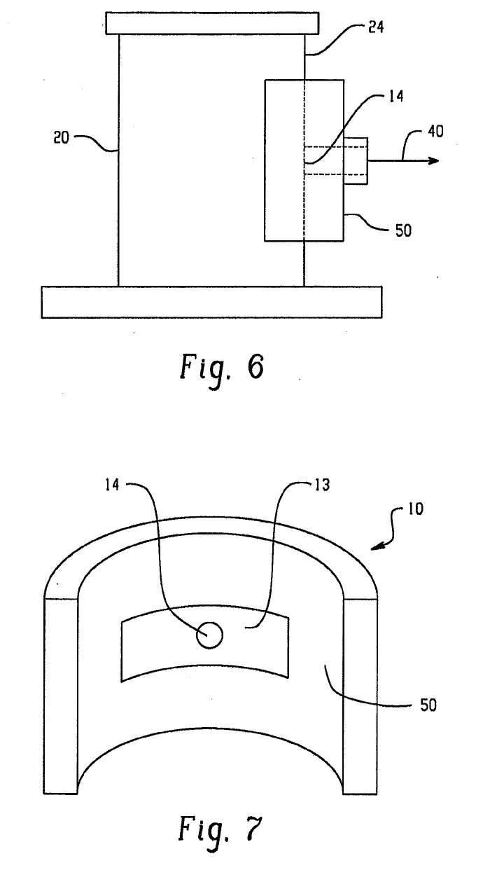

FIGS. 6 and 7 show an embodiment of a container holder 10 where the opening 14 communicates with the side of the container rather than the bottom. Referring to FIG. 6, a bracket 50 is shaped to conform substantially to the side surface 24 of the container 20. Air is drawn through opening 14, which draws the container 20 in the direction of arrow 40. Referring to FIG. 7, the surface of the bracket around opening 14 may include a pad of resilient material 13. The horizontal force that draws container 20 against resilient pad 13 increases the force of the container loading the pad, thereby increasing the system's ability to resist sliding movement of the container 20 relative to the holder 10.

It is not necessary for the container holder to include a resilient surface. Any holder configuration that allows force from suction to create a force of friction when a rotational torque is exerted can resist rotational motion of the container and carry out the purpose of the present invention.

Although the figures show a cylindrical container and a circular opening, the container may be of any shape, and the container holder adapted in shape if necessary to allow the force from suction to aid the container in resisting rotation. No particular shape of container nor any particular symmetry is necessary for the present invention.

These configurations are applicable to single-head as well as multiple-head chuck-style cappers of both in-line and rotary configurations, as well as any other capper configured to use rotational force to apply closures to containers.

In one embodiment, the pressure gradient resulting in a force from suction is created by means of either a central vacuum pump or by one or more orifice-type vacuum generators employing compressed air. Timing of application and release of the vacuum at each container position may be through a control system that employs either electrically or mechanically activated valves that are synchronized to the operating sequences of the particular capper to which them system is being applied (e.g., initiate vacuum after container has been delivered to the closure applying location, maintain vacuum during closure application and cease vacuum after completion of the closure applying operation so that the container can readily be moved out of the closure applying location to the outfeed or discharge conveyor).

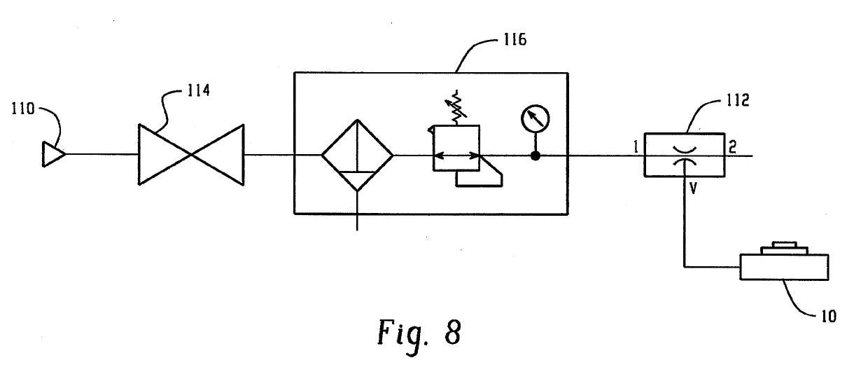

An exemplary pneumatic schematic for one embodiment is shown in FIG. 8, but many variations are possible. In the embodiment of FIG. 8, a pressure source 110 provides pressurized air (e.g., filtered, dry air under a pressure of about 90 psi) to a venturi pump 112, which utilizes the pressurized air to draw air from the container holder 10, as described above. A valve 114 (e.g., a drain ball valve) and a regulator 116 are used to control passage of pressurized air to the venturi pump 112.

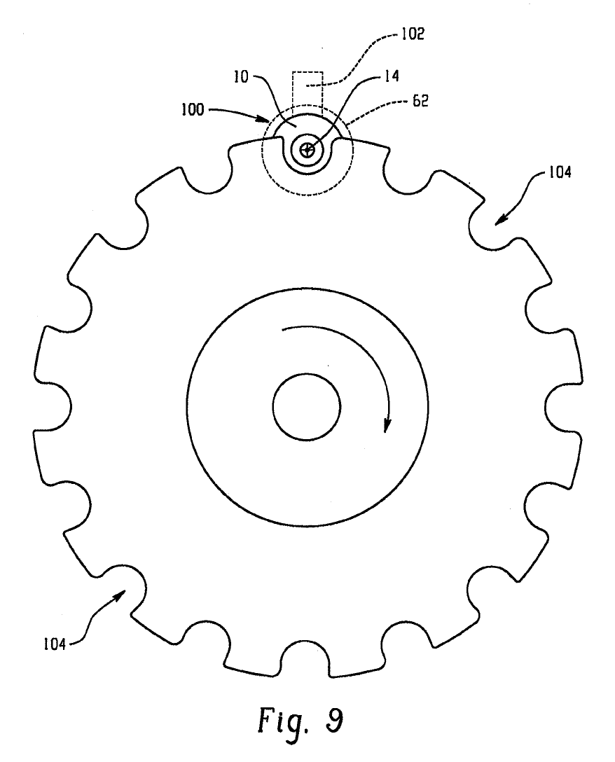

Referring to FIG. 9, in one embodiment of a closure applying system having a single capping head (represented by dashed line 62) with multiple container locations 104 that move past the capping head in a sequenced manner, the container holder 10 is in a fixed location 100 of the capping station. A stationary vacuum system 102 is connected to the container holder 10 in a fashion similar to that described above.

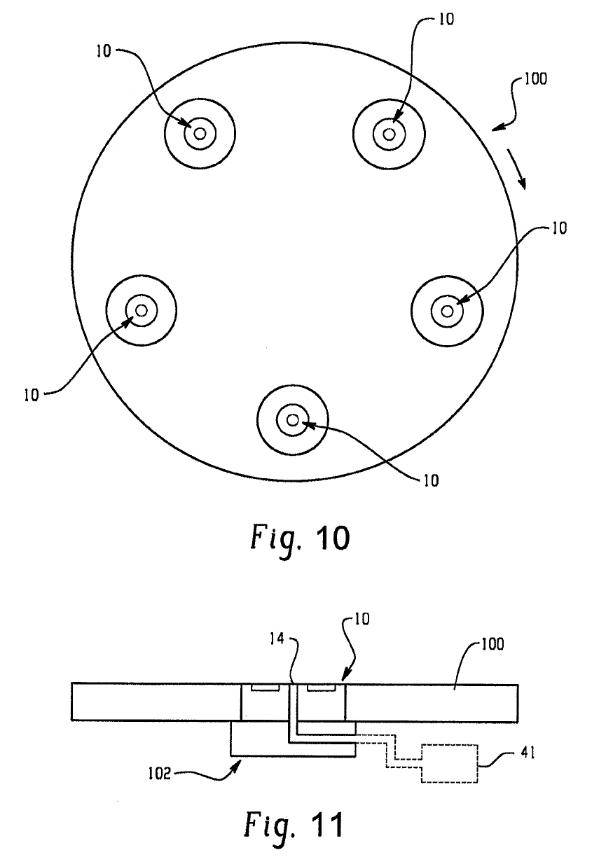

Referring to FIGS. 10 and 11, in a system with multiple capping heads (e.g., per FIG. 1) each of the container locations would be constructed so that the vacuum could be triggered and maintained (e.g., by mechanical or electrical valving) during rotation of the plate holding the container locations. In some embodiments, a single vacuum source or multiple sources could be used. The timing of triggering of a vacuum for any given container location could be set to follow another operation, such as the bumping (e.g., via a pneumatic pusher) of the container into desired positioned seated against a side collar of the container location. In a single vacuum source embodiment, as each vacuum plate assembly is rotated into alignment with system 102, a potential fluid path from the vacuum source 41 to the opening 14 in the holder is made. The vacuum can then be triggered (e.g., by mechanical or electrical valving), so that the vacuum can be triggered, the closure applied and the vacuum then terminated.

It is to be clearly understood that the above description is intended by way of illustration and example only and is not intended to be taken by way of limitation. Directional terms are given entirely for illustrational purposes, assuming the container to be upright and the closure to attach downward from above the container. However, one skilled in the art will recognize that up, down, vertical and the like are relative terms and that many other orientations are feasible. The above description allows for many variations, and one skilled in the art will find myriad changes can be made within the spirit and scope of the claimed invention, which is intended to be limited only by the claims and operation of law.

What is claimed is:

1. A container handling system for applying closures to containers, the system comprising:
a container feed line; and
a capping station for receiving containers from the container feed line and applying closures thereto, the capping station including:
a capping head configured to provide torque during closure application; and
a container holder configured to resist container rotation, the holder including an opening exposed to a container location and a device positioned to draw air from the container location through the opening to create a force the acts to pull the container toward the opening.

2. The system of claim 1, wherein the opening is positioned to interact with one or both of a side and a bottom of the container.

3. The system of claim 1, wherein the closure is a screw-on cap.

4. The system of claim 1 wherein the device is a vacuum drawing system.

5. The system of claim 4 wherein the vacuum drawing system comprises a pressurized fluid source and a venturi pump connected to the pressurized fluid source.

6. The system of claim 1 wherein the container holder further includes a resilient member circumscribing the opening and positioned to frictionally interact with a container during closure application.

7. The system of claim 6 wherein a seal is formed by the contact between the container and the resilient member.

8. The system of claim 6 wherein the force pulls the container against the resilient member to increase frictional interaction between the container and the resilient member.

9. The system of claim 8 wherein the resilient member is disposed in a horizontal orientation and engages a container bottom.

10. The system of claim 8 wherein the resilient member is oriented vertically and engages a container side.

11. A method for applying a closure to a container, the method comprising:
bringing the closure and the container in contact;
applying torque to the closure; and
exerting a vacuum force on the container to urge the container into contact with another member developing a frictional force that resists rotation of the container during the application of torque to the closure.

12. The method of claim 11 wherein the vacuum force is exerted on one or both of a side and a bottom of the container.

13. The method of claim 11 wherein the closure is a screw-on cap and the torque is applied by a capping head.

14. The method of claim 13 further comprising a step of positioning the container under the capping head.

15. The method of claim 11 wherein the step of exerting a vacuum force comprises using a vacuum drawing device to draw air from a location at which the container contacts the another member.

16. The method of claim 15 wherein the vacuum drawing device is a venturi pump.

17. A container handling system for applying closures to containers, the system comprising:
a container feed line; and
a capping station for receiving containers from the container feed line and applying closures thereto, the capping station including:
a capping head configured to provide torque during closure application;
a container holder comprising a container engaging surface; and
a vacuum system connected to the container holder that draws the container against the container engaging surface, the container engaging surface and vacuum system cooperating to inhibit rotation of the container during the closure application.

18. The container handling system of claim 17 wherein the vacuum system comprises:
a pressurized fluid source;
a venturi pump connected to the pressurized fluid source; and
a valve used to control delivery of pressurized fluid to the venturi pump, the venturi pump connected to the container holder for drawing air from a location where the container contacts the container engaging surface when pressurized fluid is delivered to the venturi pump.

19. The container handling system of claim 18 wherein the container holder comprises:
a solid member having an opening extending therethrough and a vertically oriented wall extending around the volume thereby providing a volume, the opening in communication with the venturi pump such that air is drawn from the location where the container contacts the container engaging surface through the opening; and
a resilient member located in the volume, the resilient member defining the container engaging surface and circumscribing the opening in the solid member.

20. The container handling system of claim 19 further comprising an upstanding boss through which the opening extends, the boss having one or more grooves extending along an upper surface of the boss.
